(19) United States
(12) Patent Application Publication
(10) Pub. No.: US 2024/0128619 A1
(43) Pub. Date: Apr. 18, 2024

(54) ALL-SOLID-STATE BATTERY

(71) Applicant: TDK CORPORATION, Tokyo (JP)

(72) Inventors: Shinya WATANABE, Tokyo (JP); Wen MA, Tokyo (JP)

(73) Assignee: TDK CORPORATION, Tokyo (JP)

(21) Appl. No.: 18/279,099

(22) PCT Filed: Mar. 9, 2022
(86) PCT No.: PCT/JP2022/010270

§ 371 Date: Aug. 28, 2023

(30) Foreign Application Priority Data
Mar. 10, 2021 (JP) 2021-038380

(51) Int. Cl. H01M 50/586; H01M 10/0585; H01M 50/59

(52) U.S. Cl. CPC H01M 50/586; H01M 10/0585; H01M 50/59

(57) ABSTRACT

An all-solid-state battery includes a positive electrode layer including a positive electrode active material layer and a positive electrode current collector; a negative electrode layer including a negative electrode active material layer and a negative electrode current collector; a solid electrolyte layer; and an insulating film, in which the insulating film has therein a through-hole in which a laminate in which the positive electrode active material layer, the solid electrolyte layer, and the negative electrode active material layer are sequentially stacked is housed, the laminate and the insulating film are arranged between the positive electrode current collector and the negative electrode current collector, and an external shape of the insulating film is larger than external shapes of the positive electrode current collector and the negative electrode current collector when viewed in a plan view in a laminating direction of the laminate.

### TECHNICAL FIELD

The present invention relates to an all-solid-state battery.

Priority is claimed on Japanese Patent Application No. 2021-038380, filed Mar. 10, 2021, the content of which is incorporated herein by reference.

### BACKGROUND ART

In recent years, the development of electronics technology has been remarkable, and portable electronic devices have been made smaller, lighter, thinner, and multifunctional. Accordingly, there is a strong demand for batteries being power sources for electronic devices to be smaller, lighter, thinner, and more reliable. Under these circumstances, all-solid-state batteries using solid electrolytes as electrolytes as disclosed in Patent Documents 1 to 3 have been attracting attention.

In the all-solid-state battery disclosed in Patent Document 1, a tape-shaped insulator is used on an edge part of a current-collecting foil to suppress a short circuit. This is because, in the all-solid-state battery disclosed in Patent Document 1, the external shape of the current-collecting foil is larger than the external shape of a solid electrolyte layer, and short circuits may occur when current-collecting foils come into contact with each other.

The all-solid-state battery disclosed in Patent Document 2 has a positive electrode active material layer, a solid electrolyte layer, a negative electrode active material layer, and current collector plates sandwiching the layers in the laminating direction, and a cylindrical insulating frame arranged closely to side surfaces of the current collecting plates is described in Patent Document 2. A cylindrical insulating frame is used when manufacturing an all-solid-state battery, materials used as a positive electrode layer, a negative electrode layer, and a solid electrolyte layer are housed inside the cylindrical insulating frame, and these are pressed in the laminating direction to manufacture an all-solid-state battery. It is disclosed in Patent Document 2 that, at this time, the materials of the positive electrode layer and the negative electrode layer enter between the current collector plates and the insulating frame located at the end portions in the laminating direction, and the airtightness between the current collector plates and the insulating frame is ensured.

In the all-solid-state battery disclosed in Patent Document 3, side surfaces of a positive electrode layer, a negative electrode layer, and a solid electrolyte layer are coated with a resin layer.

### CITATION LIST

### Patent Documents

### [Patent Document 1]

Japanese Unexamined Patent Application, First Publication No. 2004-134116(A)

### [Patent Document 2]

Japanese Unexamined Patent Application, First Publication No. 2011-159635(A)

### [Patent Document 3]

Japanese Unexamined Patent Application, First Publication No. 2019-192610(A)

### SUMMARY OF INVENTION

### Technical Problem

However, in the method of using the tape-shaped insulator on the edge part of the current-collecting foil as disclosed in Patent Document 1, the laminate including the positive electrode active material layer, the solid electrolyte layer, and the negative electrode active material layer may be deviated in the in-plane direction or short circuits may occur in a region closer to the laminate than the insulator.

In addition, in the all-solid-state batteries as disclosed in Patent Documents 2 and 3, cracks may form in the laminate. In addition, the all-solid-state batteries as disclosed in Patent Documents 2 and 3 require a step of coating the periphery of an all-solid-state battery with an insulating film, resulting in low production efficiency. In addition, even if slight failures occur, operations such as removing the coating are difficult, and the all-solid-state batteries as disclosed in Patent Documents 2 and 3 have low versatility.

The present invention has been made in consideration of the above-described problems, and an object of the present invention is to provide an all-solid-state battery that suppresses deviation and cracks of a laminate and occurrence of short circuits.

### Solution to Problem

The present inventors have conducted extensive studies. That is, the following means are provided to solve the above-described problems.
(1) An all-solid-state battery according to a first aspect including: a positive electrode layer including a positive electrode active material layer and a positive electrode current collector; a negative electrode layer including a negative electrode active material layer and a negative electrode current collector; a solid electrolyte layer; and an insulating film, in which the insulating film has therein a through-hole in which a laminate in which the positive electrode active material layer, the solid electrolyte layer, and the negative electrode active material layer are sequentially stacked is housed, the laminate and the insulating film are arranged between the positive electrode current collector and the negative electrode current collector, and an external shape of the insulating film is larger than external shapes of the positive electrode current collector and the negative electrode current collector when viewed in a plan view in a laminating direction of the laminate.
(2) In the all-solid-state battery according to the above-described aspect, the laminate may be thicker than the insulating film.
(3) In the all-solid-state battery according to the above-described aspect, the laminate may be arranged apart from the insulating film by 0.1 mm to 1 mm when viewed in a plan view in a laminating direction.
(4) In the all-solid-state battery according to the above-described aspect, the insulating film may be a resin.
(5) The all-solid-state battery according to the above-described aspect further including: a plurality of the laminates, in which the insulating film may have a number of through-holes corresponding to the number of the laminates, and the plurality of laminates may be respectively housed in the through-holes.
(6) The all-solid-state battery according to the above-described aspect, further including: a plurality of units each having the positive electrode layer, the negative electrode layer, the solid electrolyte layer, and the insulating film, in which the units may be electrically connected in series.
(7) The all-solid-state battery according to the above-described aspect, further including: a plurality of units each having the positive electrode layer, the negative electrode layer, the solid electrolyte layer, and the insulating film, in which the plurality of units may be electrically connected in parallel.
(8) The all-solid-state battery according to the above-described aspect, further including: a plurality of units each having the positive electrode layer, the negative electrode layer, the solid electrolyte layer, and the insulating film, in which the plurality of units may be electrically connected in series and parallel.

### Effects of the Invention

The all-solid-state battery according to the above-described aspect suppresses deviation and cracks of a laminate and occurrence of short circuits.

### BRIEF DESCRIPTION OF DRAWINGS

FIG. 1 is a perspective view of an all-solid-state battery according to the present embodiment.

FIG. 2 is a cross-sectional view of the all-solid-state battery according to the present embodiment.

FIG. 3 is a top view of the all-solid-state battery according to the present embodiment.

FIG. 4 is a top view of an all-solid-state battery according to a modification example of the present embodiment.

FIG. 5 is a top view of an all-solid-state battery according to a modification example of the present embodiment.

FIG. 6 is a cross-sectional view of an all-solid-state battery according to a modification example of the present embodiment.

FIG. 7 is a cross-sectional view of an all-solid-state battery according to a modification example of the present embodiment.

FIG. 8 is a cross-sectional view of an all-solid-state battery according to a modification example of the present embodiment.

FIG. 9 is a top view of an all-solid-state battery according to a modification example of the present embodiment.

FIG. 10 is a cross-sectional view of an all-solid-state battery according to a modification example of the present embodiment.

FIG. 11 is a top view of an all-solid-state battery according to a modification example of the present embodiment.

### DESCRIPTION OF EMBODIMENT

Hereinafter, the present embodiment will be described in detail with reference to the accompanying drawing as appropriate. In the drawings used in the following description, a part that becomes a feature of the present invention is sometimes enlarged for convenience in order to allow the feature to be easily understood, and the dimensional ratios of each constituent element and the like are sometimes different from the actual ones. The materials, dimensions, numbers, numerical values, orientations, and the like exemplified in the following description are merely examples, and the present invention is not limited thereto and can be implemented by being appropriately modified within the range that does not change the gist thereof.

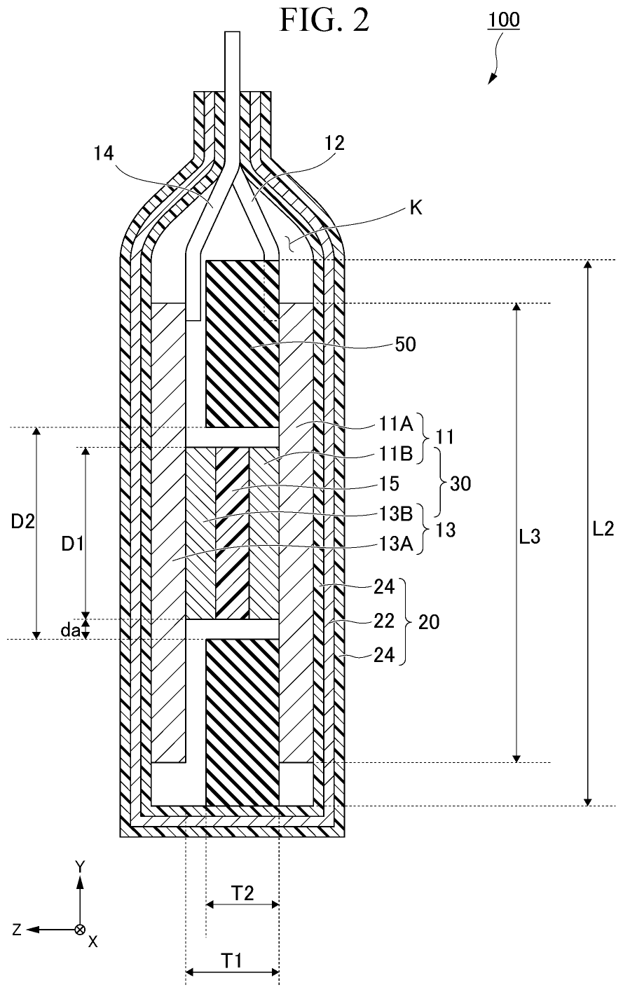

First, the directions will be defined. The direction in which layers of a laminate 30 (refer to FIG. 2) are stacked is set to a z-direction, and the directions orthogonal to the z-direction are set to an x-direction and a y-direction. The y-direction is, for example, a direction in which leads 12 and 14 extend in a plan view in the z-direction. The y-direction is, for example, the lateral direction of a power storage element 10. The x-direction is, for example, the longitudinal direction of the power storage element 10. The x direction is a direction orthogonal to the y-direction and the z-direction. Hereinafter, +z-direction may be expressed as “up”, and the −z-direction may be expressed as a “down”. Up and down do not necessarily match the direction in which gravity is applied.

### <All-Solid-State Battery>

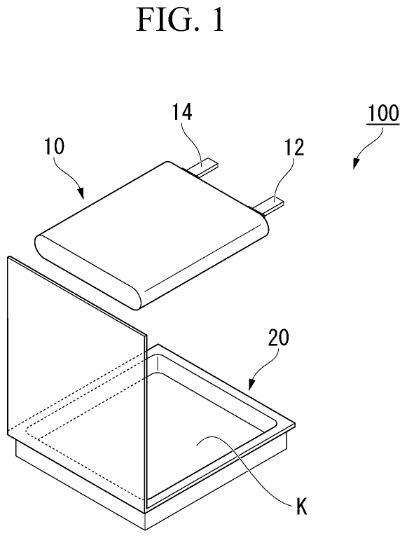

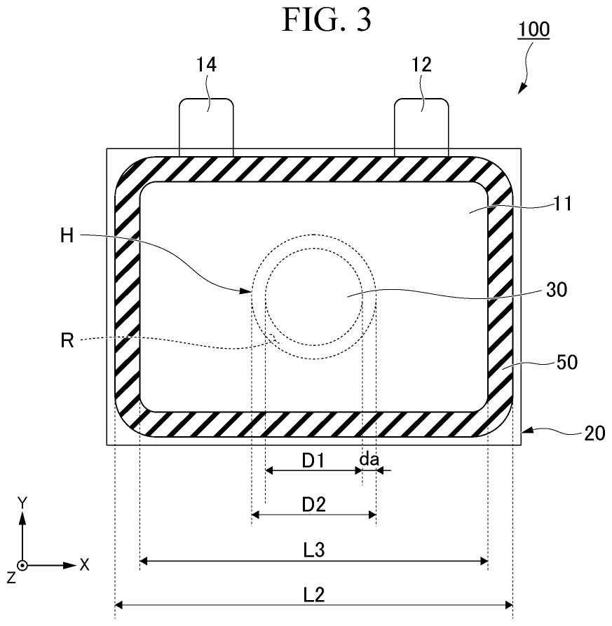

FIG. 1 is a perspective view of an all-solid-state battery 100 according to the present embodiment. FIG. 2 is a cross-sectional view of the all-solid-state battery 100 according to the present embodiment. FIG. 3 is a top view of the all-solid-state battery 100 according to the present embodiment. In FIG. 3, an exterior body 20 to be described below is simplified for convenience of explanation.

The all-solid-state battery 100 includes the power storage element 10 and the exterior body 20. The power storage element 10 is housed in a housing space K in the exterior body 20. FIG. 1 shows a state immediately before the power storage element 10 is housed in the exterior body 20 to facilitate understanding.

### “Exterior Body”

The exterior body 20 includes, for example, a metal foil and resin layers 24 stacked on both surfaces of the metal foil 22 (refer to FIG. 2). The exterior body 20 is a metal laminated film obtained by coating both sides of a metal foil with polymer films (resin layers). The metal foil 22 is, for example, aluminum foil. The resin layers 24 are, for example, polymer films of such as polypropylene. The inner and outer resin layers 24 may be different from each other. For example, polyethylene terephthalate (PET) and polyamide (PA) having a high melting point can be used for the outer resin layer, and polyethylene (PE), polypropylene (PP), and the like having high heat resistance, oxidation resistance, and reduction resistance can be used for the inner resin layer.

### “Power Storage Element”

The power storage element 10 includes a positive electrode layer 11, a negative electrode layer 13, a solid electrolyte layer 15, an insulating film 50, and leads 12 and 14 electrically connected to outside. The positive electrode layer 11, the negative electrode layer 13, and the solid electrolyte layer 15 each extend in the xy plane. The positive electrode layer 11 includes, for example, a positive electrode current collector 11A and a positive electrode active material layer 11B. The negative electrode layer 13 includes, for example, a negative electrode current collector 13A and a negative electrode active material layer 13B. The solid electrolyte layer 15 is positioned, for example, between the positive electrode active material layer 11B and the negative electrode active material layer 13B.

The negative electrode active material layer 13B, the solid electrolyte layer 15, and the positive electrode active material layer 11B are stacked in this order in the z-direction to form a laminate 30. The laminate 30 is arranged between the positive electrode current collector 11A and the negative electrode current collector 13A. The shape of the laminate 30 when viewed in a plan view in the z-direction is, for example, circular. The diameter of the laminate 30 when viewed in a plan view in the z-direction is referred to as a diameter D1. The thickness of the laminate 30 in the z-direction is referred to as a thickness T1. The laminate 30 is housed in a through-hole H to be described below in a plan view in the z-direction.

The all-solid-state battery 100 is charged or discharged by giving and receiving electrons through the positive electrode current collector 11A and the negative electrode current collector 13A and by giving and receiving lithium ions through the solid electrolyte layer 15. The all-solid-state battery 100 may be a laminate in which the positive electrode layer 11, the negative electrode layer 13, and the solid electrolyte layer are stacked, or a wound body thereof. The all-solid-state battery 100 is used, for example, as a laminate battery, a square battery, a cylindrical battery, a coin type battery, and a button-type battery.

### “Positive Electrode Layer”

The positive electrode layer 11 includes, for example, a positive electrode current collector 11A and a positive electrode active material layer 11B containing a positive electrode active material.

### (Positive Electrode Current Collector)

The positive electrode current collector 11A preferably has high conductivity. The positive electrode current collector 11A is, for example, metals such as silver, palladium, gold, platinum, aluminum, copper, nickel, titanium, stainless steel, and their alloys, or conductive resins. The length of the positive electrode current collector 11A in the y-direction is referred to as a length L3.

### (Positive Electrode Active Material Layer)

The positive electrode active material layer 11B is formed on a single surface or both surfaces of the positive electrode current collector 11A. The positive electrode active material layer 11B contains a positive electrode active material, and as necessary, may contain a conductive assistant, a binder, and a solid electrolyte to be described below.

### (Positive Electrode Active Material)

A positive electrode active material is, for example, a lithium-containing transition metal oxide, a transition metal fluoride, a polyanion, a transition metal sulfide, a transition metal oxyfluoride, a transition metal oxysulfide, and a transition metal oxynitride.

The positive electrode active material is not particularly limited as long as it can reversibly progress release and absorption of lithium ions and desorption and insertion of lithium ions. For example, positive electrode active materials used in well-known lithium ion secondary batteries can be used.

Specific examples of positive electrode active materials include lithium cobaltate (LiCoO₂), lithium nickelate (LiNiO₂), lithium manganese spinel (LiMn₂O₄), composite metal oxides represented by general formula: LiNiₓCo_{y}Mn_{z}MaO₂ (x+y+z+a=1, 0≤x≤1, 0≤y≤1, 0≤z≤1, 0≤a≤1, and M is one or more kinds of elements selected from Al, Mg, Nb, Ti, Cu, Zn, and Cr), lithium vanadium compounds (LiV₂O₅, Li₃V₂ (PO₄)₃, and LiVOPO4), olivine-type LiMPO₄ (where M represents one or more kinds of elements selected from Co, Ni, Mn, Fe, Mg, V, Nb, Ti, Al, and Zr), lithium titanate (Li₄Ti₅O₁₂), and composite metal oxides such as LiNiₓCo_{y}Al_{z}O₂ (0.9<x+y+z<1.1).

In addition, if a negative electrode active material doped with metallic lithium or lithium ions is arranged in a negative electrode in advance, a positive electrode active material that does not contain lithium can also be used by starting the battery from discharging. Examples of positive electrode active materials include lithium-free metal oxides (such as MnO₂ and V₂O₅), lithium-free metal sulfides (such as MoS₂), and lithium-free fluorides (such as FeF₃ and VF₃).

### “Negative Electrode Layer”

The negative electrode layer 13 includes the negative electrode current collector 13A and the negative electrode active material layer 13B containing a negative electrode active material.

### (Negative Electrode Current Collector)

The negative electrode current collector 13A preferably has high conductivity. As the negative electrode current collector 13A, for example, metals such as silver, palladium, gold, platinum, aluminum, copper, nickel, stainless steel, iron, and their alloys, or conductive resins are preferably used. The negative electrode current collector 13A may be in powder, foil, punched, or expanded form. The length of the negative electrode current collector 13A in the y-direction is, for example, a length L3. The lengths of the positive electrode current collector 11A and the negative electrode current collector 13A in the y-direction may be the same as or different from each other.

### (Negative Electrode Active Material Layer)

The negative electrode active material layer 13B is formed on a single surface or both surfaces of the negative electrode current collector 13A. The negative electrode active material layer 13B contains, for example, a negative electrode active material. The negative electrode active material layer 13B may contain, as necessary, a conductive assistant, a binder, and a solid electrolyte to be described below.

### (Negative Electrode Active Material)

The negative electrode active material contained in the negative electrode active material layer 13B may be a compound capable of absorbing and releasing mobile ions, and negative electrode active materials used in well-known lithium ion secondary batteries can be used. Examples of negative electrode active materials include alkali metal simple substances, alkali metal alloys, graphite (natural graphite and artificial graphite), carbon materials such as carbon nanotubes, hardly graphitized carbon, easily graphitized carbon, and low temperature calcined carbon, metals that can combine with metals such as alkali metals such as aluminum, silicon, tin, germanium and their alloys, SiOₓ(0<x<2), oxides such as iron oxide, titanium oxide, and tin dioxide, and lithium metal oxides such as lithium titanate (Li₄Ti₅O₁₂).

### (Conductive Assistant)

A conductive assistant is not particularly limited as long as it improves electron conductivity of the positive electrode active material layer 11B and the negative electrode active material layer 13B, and well-known conductive assistants can be used. Examples of conductive assistants include carbon-based materials such as graphite, carbon black, graphene, and carbon nanotubes, metals such as gold, platinum, silver, palladium, aluminum, copper, nickel, stainless steel, and iron, conductive oxides such as ITO, or mixtures thereof. The conductive assistant may be in powder or fiber form.

### (Binding Material)

A binding material bonds the positive electrode current collector 11A with the positive electrode active material layer 11B, the negative electrode current collector 13A with the negative electrode active material layer 13B, the positive electrode active material layer 11B and the negative electrode active material layer 13B with the solid electrolyte layer 15, various materials constituting the positive electrode active material layer 11B, and the various materials constituting the negative electrode active material layer 13B.

The binding material is used, for example, within a range that does not impair the functions of the positive electrode active material layer 11B and the negative electrode active material layer 13B. The binding material can be anything that enables the bonding described above, and examples thereof include fluororesins such as polyvinylidene fluoride (PVDF) and polytetrafluoroethylene (PTFE). Furthermore, in addition to the above, cellulose, styrene-butadiene rubber, ethylene-propylene rubber, a polyimide resin, and a polyamideimide resin may be used as binding materials. In addition, a conductive polymer having electron conductivity and an ion-conductive polymer having ionic conductivity may be used as a binding material. Examples of conductive polymers having electron conductivity include polyacetylene. In this case, since the binding material also exhibits the function of conductive assistant particles, a conductive assistant may not be incorporated. As ion-conductive polymers having ionic conductivity, for example, those that conduct lithium ions and the like can be used, and examples thereof include those obtained by combining monomers of polymer compounds (polyether polymer compounds such as polyethylene oxide and polypropylene oxide, and polyphosphazene), with lithium salts such as LiClO₄, LiBF₄, LiPF₆, LiTFSI, and LiFSI or alkali metal salts mainly composed of lithium. Polymerization initiators used for combination include thermal polymerization initiators or photopolymerization initiators compatible with the above-described monomers. Examples of properties required for binding materials include oxidation-reduction resistance and favorable adhesiveness. If the binding materials are unnecessary, these may not be incorporated.

The content of a binder in the positive electrode active material layer 11B is not particularly limited but is preferably 0.5 to 30 volume % of the positive electrode active material layer from the viewpoint of lowering resistance of the positive electrode active material layer 11B. In addition, the content of a binder in the positive electrode active material layer 11B is preferably 0 volume % from the viewpoint of improving energy density.

The content of a binder in the negative electrode active material layer 13B is not particularly limited but is preferably 0.5 to 30 volume % of the negative electrode active material layer from the viewpoint of lowering resistance of the negative electrode active material layer 13B. In addition, the content of a binder in the negative electrode active material layer 13B is preferably 0 volume % from the viewpoint of improving energy density.

### “Solid Electrolyte Layer”

The solid electrolyte layer 15 is located between the positive electrode layer 11 and the negative electrode layer 13. The solid electrolyte layer 15 contains a solid electrolyte. A solid electrolyte is a substance (for example, particles) in which ions can be moved by an externally applied electric field. In addition, the solid electrolyte layer is an insulator that inhibits movement of electrons.

The solid electrolyte contains, for example, lithium. The solid electrolyte may be, for example, any of an oxide-based material, a halide-based material, and a sulfide-based material. The solid electrolyte may be, for example, any of a perovskite-type compound, a LISICON-type compound, a garnet-type compound, a NASICON-type compound, thio-LISICON-type compound, a glass compound, and a phosphoric acid compound. La_{0.5}Li_{0.5}TiO₃ is an example of a perovskite-type compound. Li₁₄Zn(GeO₄)₄ is an example of a LISICON-type compound. Li₇La₃Zr₂O₁₂ is an example of a garnet-type compound. LiZr₂(PO₄)₃, Li_{1.3}Al_{0.3}Ti_{1.7}(PO₄)₃, Li_{1.5}Al_{0.5}Ge_{1.5}(PO₄)₃, Li_{1.55}Al_{0.2}Zr_{1.7}Si_{0.25}P_{9.75}O₁₂, Li_{1.4}Na_{0.1}Zr_{1.5}Al_{0.5}(PO₄)₃, Li_{1.4}Ca_{0.25}Er_{0.3}Zr_{1.7}(PO₄)_{3.2}, and Li_{1.4}Ca_{0.25}Yb_{0.3}Zr_{1.7}(PO₄)_{3.2} are examples of NASICON-type compounds. Li_{3.25}Ge_{0.25}P_{0.75}S₄ and Li₃PS₄ are examples of thio-LISICON-type compounds. Li₂S—P₂S₅ and Li₂O—V₂O₅—SiO₂ are examples of glass compounds. Li₃PO₄, Li_{3.5}Si_{0.5}P_{0.5}O₄, and Li_{2.9}PO_{3.3}N_{0.46} are examples of phosphoric acid compounds. The solid electrolyte may contain one or more kinds of these compounds.

The solid electrolyte layer 15 may contain a substance other than the solid electrolyte material. For example, the solid electrolyte layer 15 may contain an oxide or halide of an alkali metal element or an oxide or halide of a transition metal element. In addition, the solid electrolyte layer 15 may contain a binding material. The binding material is the same as described above.

### “Insulating Film”

The insulating film 50 is arranged between the positive electrode current collector 11A and the negative electrode current collector 13A. The insulating film 50 extends in the xy plane. The insulating film 50 is at least one insulating film. The insulating film 50 may be formed by laminating a plurality of insulating films and integrating them. In a case where a plurality of insulating films are stacked and integrated, these can be fixed to the positive electrode current collector 11A, for example, with tape in the stacked state. Hereinafter, although a case of one sheet of the insulating film 50 will be described as an example, the same may be applied to a case where a plurality of insulating films 50 are stacked and integrated. For example, in the case where the plurality of insulating films 50 are stacked and integrated, the thickness T2 of the insulating films 50 to be described below is a total value of the thicknesses of the stacked plural insulating films.

The insulating film 50 is, for example, an insulating resin. Well-known insulating materials can be used as the insulating film 50. The insulating film 50 is preferably an insulating film that is easy to process. The insulating film 50 is preferably, for example, polyethylene terephthalate, polypropylene, polyimide, and PTFE. The insulating film 50 is, for example, Lumirror H10 (manufactured by Toray Industries Inc.).

The insulating film 50 has therein a through-hole H penetrating in the z-direction. The number of through-holes H of the insulating film 50 is an arbitrary number of at least one. The laminate 30 is housed in a through-hole H.

The shape of the through-hole H when viewed in a plan view in the z-direction is an arbitrary shape that allows the laminate 30 to be housed in the insulating film 50. The shape of the through-hole H when viewed in a plan view in the z-direction is, for example, similar to the laminate 30. Hereinafter, a case where the shapes of the through-hole H and the laminate 30 are circular will be described as an example.

The through-hole H when viewed in a plan view in the z-direction is larger than the laminate 30. That is, a diameter D2 of the through-hole H when viewed in a plan view in the z-direction is larger than the diameter D1 of the laminate 30. For this reason, the insulating film 50 and the laminate 30 are spaced apart by a distance d a. That is, there is a space R between the insulating film 50 and the laminate 30. Although FIG. 3 shows a case where the distance between the insulating film 50 and the laminate is constant at any position, the distance between the insulating film 50 and the laminate 30 may vary depending on the location. In this case, the shortest distance is set to the distance dₐ.

The difference (D2-D1) between the diameter D2 of the through-hole H and the diameter D1 of the laminate 30, that is, a distance 2d a obtained by doubling the distance between the laminate 30 and the insulating film 50 in a plan view in a laminating direction, is, for example, 0.1 mm to 1 mm, and may be 0.5 mm to 1 mm. A diameter ratio D1/D2 between the laminate 30 and the through-hole H is, for example, 0.9 or higher and lower than 1, and may be 0.9 to 0.97.

Since it is designed to create a gap between the laminate 30 and the insulating film 50, the risk of the laminate 30 cracking when the laminate 30 is fitted into the through-hole of the insulating film 50 in the manufacturing process can be suppressed. In addition, the interior of the exterior body 20 may be evacuated in the manufacturing process. When the insulating film 50 and the laminate 30 are separated from each other, there is a marginal space R in which the laminate 30 can be slightly deviated in the in-plane direction within the through-hole H. Therefore, even if stress is applied to the laminate 30 in the in-plane direction, the stress can be restrained from being applied directly to the laminate 30. In addition, in a case where an all-solid-state battery in which the insulating film 50 and the laminate 30 are in close contact with each other is manufactured, stress is applied from the insulating film 50 to the laminate 30 when the interior of the exterior body 20 is evacuated in the manufacturing process, whereby cracks may form in the laminate 30. On the other hand, in the case where there is a space R between the insulating film 50 and the laminate 30 as in the present embodiment, stress can be restrained from being applied from the insulating film 50 to the laminate 30 in the manufacturing process.

In addition, by arranging the insulating film 50 and the laminate 30 close to each other, it is possible to prevent the laminate 30 from being largely deviated. In addition, by arranging the insulating film 50 and the laminate 30 close to each other, it is possible to prevent the positive electrode current collector 11A or the negative electrode current collector 13A from entering the space R between the insulating film 50 and the laminate 30 during evacuation. If the positive electrode current collector 11A or the negative electrode current collector 13A enters the space R, there is a concern that the laminate 30 and the positive electrode current collector 11A or the negative electrode current collector 13A may be short-circuited.

The external shape of the insulating film 50 when viewed in a plan view in the z-direction is larger than external shapes of the positive electrode current collector 11A and the negative electrode current collector 13A. That is, the area of the insulating film 50 having a portion of the through-hole H when viewed in a plan view in the z-direction is larger than the area of the positive electrode current collector 11A and the negative electrode current collector 13A. For example, the length L2 of the insulating film 50 in the y-direction is longer than the length L3 of the positive electrode current collector 11A and the negative electrode current collector 13A in the y-direction. The length L2 may be, for example, longer than the length L3 by 0.5 mm to 2 mm, or 1 mm to 2 mm. In addition, the ratio L3/L2 between the length L3 and the length L2 is, for example, 0.91 to 0.98, and may be 0.91 to 0.95. In addition, for example, the length of the insulating film 50 in the x-direction is longer than the length of the positive electrode current collector 11A and the negative electrode current collector 13A in the x-direction. Here, the external shape of the insulating film 50 when viewed in a plan view in the z-direction is preferably larger than the external shapes of the positive electrode current collector 11A and the negative electrode current collector 13A in all in-plane directions, but may be partially smaller than the positive electrode current collector 11A and the negative electrode current collector 13A. The insulating film 50 may be arranged symmetrically with respect to the center of gravity of the positive electrode current collector 11A and the negative electrode current collector 13A in the xy plane.

The length difference and length ratio between the insulating film 50 and the positive electrode current collector 11A and the negative electrode current collector 13A in the x-direction can be set to be the same as the length difference and length ratio between the insulating film 50 and the positive electrode current collector 11A and the negative electrode current collector 13A in the y-direction.

The thickness T2 of the insulating film 50 is, for example, equal to the thickness T1 of the laminate 30 or less than the thickness T1 of the laminate 30. The thickness ratio (T2/T1) between the insulating film 50 and the laminate 30 is, for example, 0.9 or lower, and may be 0.65 or lower. The thickness ratio (T2/T1) between the insulating film 50 and the laminate 30 is, for example, 0.2 or higher, and may be 0.5 or higher. In a case where the insulating film 50 is thinner than the laminate 30, the insulating film 50 does not come into contact with the positive electrode current collector 11A and the negative electrode current collector 13A outside the z-direction than the laminate 30. For this reason, in a case where the power storage element 10 is pressed with a flat plate when manufacturing the all-solid-state battery 100, the insulating film 50 does not become an obstacle to contact between the laminate 30 and the positive electrode current collector 11A and the negative electrode current collector 13A. Accordingly, in the case where the insulating film 50 is thinner than the laminate 30, the adhesiveness between the laminate 30 and the positive electrode current collector 11A and between the laminate 30 and the negative electrode current collector 13A is enhanced, and the deviation of the laminate 30 is further suppressed. In addition, if the thickness of the insulating film 50 is thicker than a predetermined value, effects of suppressing short circuits and deviation of a laminate are particularly likely to be obtained.

The insulating film 50 may be fixed to the adjacent positive electrode current collector 11A and negative electrode current collector 13A with tape. Tape may be arranged to sandwich the insulating film 50, and double-sided tape or the like may be used. In addition, the insulating film 50 may have a configuration in which a plurality of insulating films are stacked and integrated as described above.

In addition, the exterior body 20 may be sandwiched between metal plates via a baking plate, and four corners of the metal plates may be fastened and restrained with bolts and nuts.

In the all-solid-state battery 100 according to the present embodiment, it is possible to suppress deviation of the laminate 30 in the in-plane direction, cracking of the laminate 30, and occurrence of short circuits.

“Method for Manufacturing all-Solid-State Battery”

Next, a method for manufacturing all-solid-state batteries according to the present embodiment will be described. The all-solid-state battery according to the present embodiment may be manufactured through a powder molding method or through a sintering method. Hereinafter, a case of using a powder molding method will be described as an example.

### (Method for Producing Laminate)

In the case of producing a laminate through a powder molding method, a resin holder having a through-hole in the center, lower punch, and an upper punch are first prepared. A metal holder made of die steel may be used instead of the resin holder to improve moldability. The diameter of the through-hole of the resin holder can be set to a desired size as the diameter D1 of the laminate 30. The diameter of the through-hole of the resin holder is set to, for example, 10 mm, and the diameters of the lower punch and the upper punch are set to, for example, 9.99 mm. The lower punch is inserted from below the through-hole of the resin holder, and a powdery solid electrolyte is arranged from the opening side of the resin holder. Next, the upper punch is inserted from above the arranged powdery solid electrolyte, arranged on a press, and pressed. The pressure of the press is set to, for example, 5 kN (1.7 MPa). The powdery solid electrolyte is pressed by the upper punch and the lower punch in the resin holder to form the solid electrolyte layer 15.

Next, the upper punch is once removed, and the material for a positive electrode active material layer is arranged on the upper punch of the solid electrolyte layer 15. Thereafter, the upper punch is inserted thereinto again and pressed. The pressure of the press is set to, for example, 5 kN (1.7 MPa). The material for the positive electrode active material layer becomes the positive electrode active material layer 11B through pressing.

Next, the lower punch is once removed, and the material for a negative electrode active material layer is arranged on the lower punch of the solid electrolyte layer 15. For example, the material for negative electrode active material layer is arranged on the solid electrolyte layer 15 so that the sample is turned upside down and faces the positive electrode active material layer 11B. Thereafter, the lower punch is inserted thereinto again and pressed. The pressure of the press is set to, for example, 5 kN (1.7 MPa). Thereafter, a pressure of 20 kN (7 MPa) is applied for main molding. The material for the negative electrode active material layer becomes the negative electrode active material layer 13B by reapplying strong pressure after temporary molding.

Next, the laminate 30 in which the positive electrode active material layer 11B, the solid electrolyte layer 15, and the negative electrode active material layer 13B are sequentially stacked is removed from the resin holder. To remove the laminate 30 from the resin holder, for example, the upper punch is inserted and pressed in a state where the lower punch is removed. In addition, the lower punch is inserted and pressed in a state where the upper punch is removed. The laminate 30 is obtained in this manner.

### (Method for Manufacturing Insulating Film)

An insulating film is obtained by, for example, forming a through-hole in an insulating film having a predetermined external shape. That is, an insulating film having a predetermined external shape is first prepared.

Next, the insulating film is pressed with a molding die and cut. The mold die has a shape of a desired through-hole H. The molding die is installed at a desired position for forming a through-hole in the insulating film. A punching blade is used to cut the insulating film. A Pinnacle blade (registered trademark) or the like can be used as the punching blade.

### (Manufacturing of Positive Electrode Current Collector and Negative Electrode Current Collector)

The positive electrode current collector 11A and the negative electrode current collector 13A are obtained by punching a current collector material into a desired shape using, for example, a punching blade. For example, a Pinnacle blade (registered trademark) or the like can be used as the punching blade.

(Assembly of all-Solid-State Battery)

An insulating film 50 is attached to any one of the prepared positive electrode current collector 11A and the negative electrode current collector 13A. Hereinafter, an example in which the insulating film 50 is attached to the positive electrode current collector 11A will be described, but the insulating film 50 may be attached to the negative electrode current collector 13A. The insulating film 50 is fixed to, for example, the positive electrode current collector 11A using tape. As a specific example, one main surface and side surface of the insulating film 50 and one side surface and main surface of the positive electrode current collector 11A are fixed in contact with tape. The fixation of the insulating film 50 to the positive electrode current collector 11A using tape may be performed, for example, on three sides out of four sides of the insulating film 50 in the xy plane.

Subsequently, the leads 12 and 14 are each attached to the positive electrode current collector 11A and the negative electrode current collector 13A. The leads 12 and 14 can be respectively joined to the positive electrode current collector 11A and the negative electrode current collector 13A through, for example, ultrasonic welding.

Next, the laminate 30 is housed in the through-hole H of the insulating film 50 using forceps or the like.

Next, the negative electrode current collector 13A and the positive electrode current collector 11A are respectively stacked on the laminate 30 and the insulating film 50 to sandwich them, and are fixed with tape.

Next, opening portions of the exterior body 20 are heat-sealed except for one opening portion. Thereafter, the remaining opening portion may be heat-sealed while evacuating the interior of the exterior body 20. By performing heat-sealing while evacuating, the exterior body 20 can be sealed in a state in which the amount of gas and moisture present in the housing space K is small.

Subsequently, the exterior body 20 is sandwiched between metal plates via a baking plate, and four corners of the metal plates are fastened and restrained with bolts and nuts. Here, as the metal plates, those having a size larger than that of the exterior body 20 in the x-direction or the y-direction can be used.

The all-solid-state battery 100 of the present embodiment is obtained through the above-described steps. In the method for manufacturing an all-solid-state battery of the present embodiment, the insulating film 50 having a through-hole H is obtained simply by pressing an insulating film with a molding die. For this reason, in the method for manufacturing an all-solid-state battery of the present embodiment, the shape and number of through-holes H can be adjusted simply by changing the number and shape of molding dies. Accordingly, in the method for manufacturing an all-solid-state battery of the present embodiment, it is possible to simply manufacture the all-solid-state battery 100. In addition, in the method for manufacturing an all-solid-state battery of the present embodiment, since it is easy to form the insulating film 50 into a desired structure, it is easy to cope with an increase in capacity of batteries, such as multilayer and large-area batteries.

A specific example of the all-solid-state battery 100 according to a first embodiment has been described in detail above. The present invention is not limited to this example and various modifications and changes can be made within the scope of the gist of the present invention disclosed in the claims.

### Modification Example 1

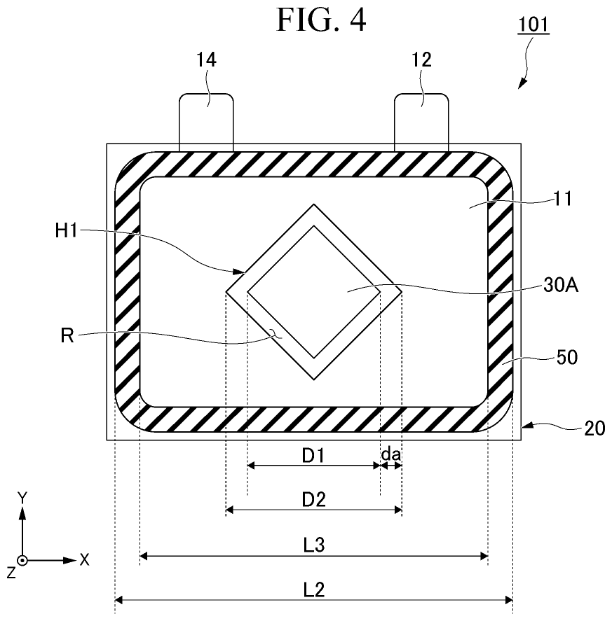

FIG. 4 is a schematic top view of an all-solid-state battery 101 according to Modification Example 1. The all-solid-state battery 101 according to the Modification Example 1 differs from the all-solid-state battery 100 in the shapes of a laminate 30A and a through-hole H1. In the all-solid-state battery 101, the same configurations as in the all-solid-state battery 100 are given the same reference numerals, and description thereof will not be repeated.

The shapes of the laminate 30A and the through-hole H1 when viewed in a plan view in the z-direction is an arbitrary shape such as a polygonal shape or an elliptical shape. In this manner, the shapes of the laminate 30A and the through-hole H1 when viewed in a plan view in the z-direction may not be circular.

Even with the all-solid-state battery 101 according to Modification Example 1, the same effects as those of the all-solid-state battery 100 according to the first embodiment are obtained. In addition, when the shapes of the laminate 30A and the through-hole H1 are polygonal or elliptical, even if the insulating film 50 and the laminate 30 come into contact with each other, the contact area can be increased, and stress can be suppressed from being locally concentrated. In Modification Example 1, the maximum length of the plan view shape of the laminate 30A in the z-direction can be treated as a diameter D1 of the laminate. In addition, in Modification Example 1, the maximum length of the plan view shape of the through-hole H1 of the insulating film 50 in the z-direction can be treated as a diameter D2 of the through-hole H1.

### Modification Example 2

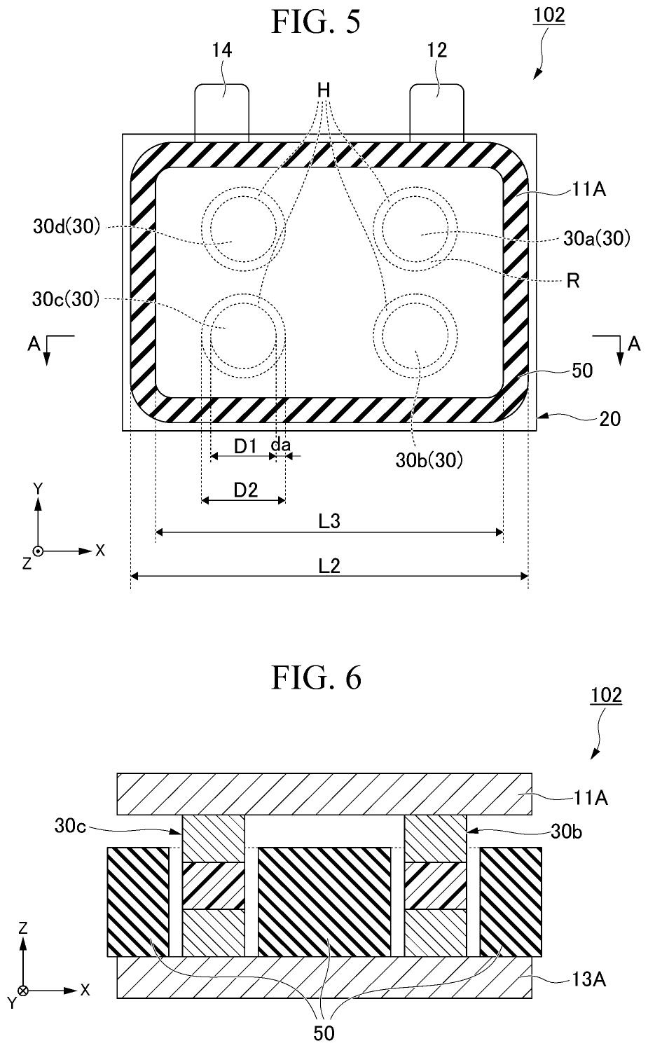

FIG. 5 is a schematic top view of an all-solid-state battery 102 according to Modification Example 2. FIG. 6 is a cross-sectional schematic view of the all-solid-state battery 102 according to Modification Example 2 and is a cross-sectional view taken along cut line A-A. The all-solid-state battery 102 according to Modification Example 2 differs from the all-solid-state battery 100 according to the first embodiment in that the insulating film 50 has therein a plurality of through-holes H. In the all-solid-state battery 102, the same configurations as in the all-solid-state battery 100 are given the same reference numerals, and description thereof will not be repeated.

The all-solid-state battery 102 includes: an insulating film 50 having a plurality of through-holes H; and a plurality of laminates 30. The number of laminates 30 corresponds to, for example, the number of through-holes H. In FIGS. 5 and 6, a case where four laminates 30a to 30d will be described as an example. The plurality of through-holes H and the plurality of laminates 30 are, for example, housed in the same plane. That is, the plurality of laminates 30 and the plurality of through-holes H are arranged between the same positive electrode current collector 11A and negative electrode current collector 13A. The plurality of laminates 30 and the plurality of through-holes H are, for example, arranged symmetrically with respect to the center of gravity of the positive electrode current collector. In this manner, in the all-solid-state battery 102, the laminates 30a to 30d are electrically arranged in parallel between the positive electrode current collector 11A and the negative electrode current collector 13A.

Even with the all-solid-state battery 102 according to Modification Example 2, the same effects as those of the all-solid-state battery 100 according to the first embodiment are obtained. In addition, since the all-solid-state battery 102 has four times as many laminates 30 as the all-solid-state battery 100, it has been experimentally confirmed that the battery capacity is approximately four times that of the all-solid-state battery 100. In addition, it has been experimentally confirmed that the battery capacity increases in accordance with the number of laminates included in the all-solid-state battery 102.

### Modification Example 3

Modification Example 3 differs from the all-solid-state battery 100 in that a plurality of power storage elements 10 are provided in the laminating direction. Other points are the same as those of the all-solid-state battery 100, and the same configurations as therein are given the same reference numerals, and description thereof will not be repeated. In the present embodiment, a configuration including one each of the positive electrode layer 11, the negative electrode layer 13, the solid electrolyte layer 15, and the insulating film 50 may be referred to as a unit.

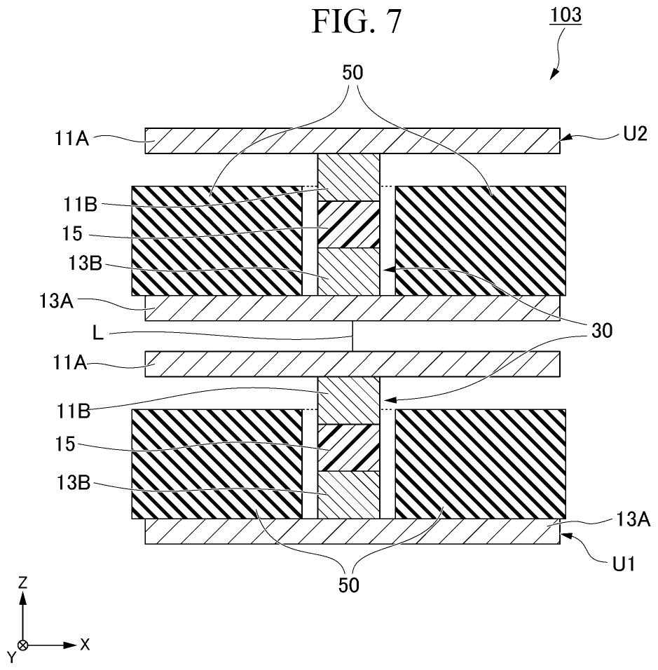

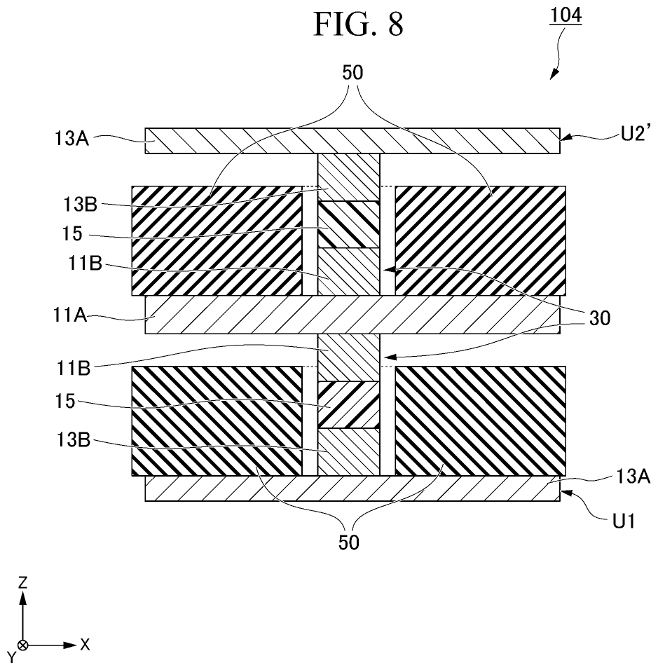

FIGS. 7 and 8 are schematic top views of all-solid-state batteries 103 and 104 according to Modification Example 3. The arrangement of the all-solid-state batteries 103 and 104 according to Modification Example 3 when viewed in a plan view in a laminating direction is the same as the arrangement of the all-solid-state battery 100 according to the first embodiment. The all-solid-state batteries 103 and 104 are example of arrangement when electrically connected in series and parallel, respectively.

In the all-solid-state battery 103, a second unit U2 is stacked on a first unit U1 in the z-direction. The configuration of each of the first unit U1 and the second unit U2 is the same as that of the single unit of the all-solid-state battery 100. The first unit U1 and the second unit U2 are, for example, electrically connected in series via a conductive wire L. In the all-solid-state battery 103, a lead 12 is connected to a positive electrode current collector 11A of the second unit U2. A lead 14 is connected to a negative electrode current collector 13A of the first unit U1.

In the all-solid-state battery 104, a second unit U2′ is stacked on a first unit U1 in the z-direction. In the all-solid-state battery 104, current collectors at both ends in the z-direction are arranged to have the same polarity. For example, the second unit U2′ has a structure in which the second unit U2 is inverted. The polarity of the inner current collector in the z-direction is different from the polarities of the current collectors at both ends in the z-direction. The inner current collector in the z-direction may be shared by the first unit U1 and the second unit U2′, or may be prepared independently for each of the first unit U1 and the second unit U2′ and electrically connected to each other via a conductive wire. In the all-solid-state battery 104 shown in FIG. 8, a lead 12 is connected to a positive electrode current collector 11A located on the inner side in the z-direction. A plurality of leads 14 are prepared and connected to respective current collectors located at both ends in the z-direction. That is, in FIG. 8, the lead 12 is connected to the positive electrode current collector 11A, and two leads 14 are respectively connected to the negative electrode current collectors 13A.

Even with the all-solid-state battery 103 according to Modification Example 3, the same effects as those of the all-solid-state battery 100 are obtained. In addition, since the all-solid-state battery 103 has twice as many units electrically connected in series as the all-solid-state battery 100, it has been experimentally confirmed that the voltage output can be approximately doubled. In addition, since the all-solid-state battery 104 has twice as many units electrically connected in parallel as the all-solid-state battery 100, it has been experimentally confirmed that the battery capacity is approximately doubled and the resistance is approximately halved. The inverted unit may be reversed from the example shown in FIG. 8.

### Modification Example 4

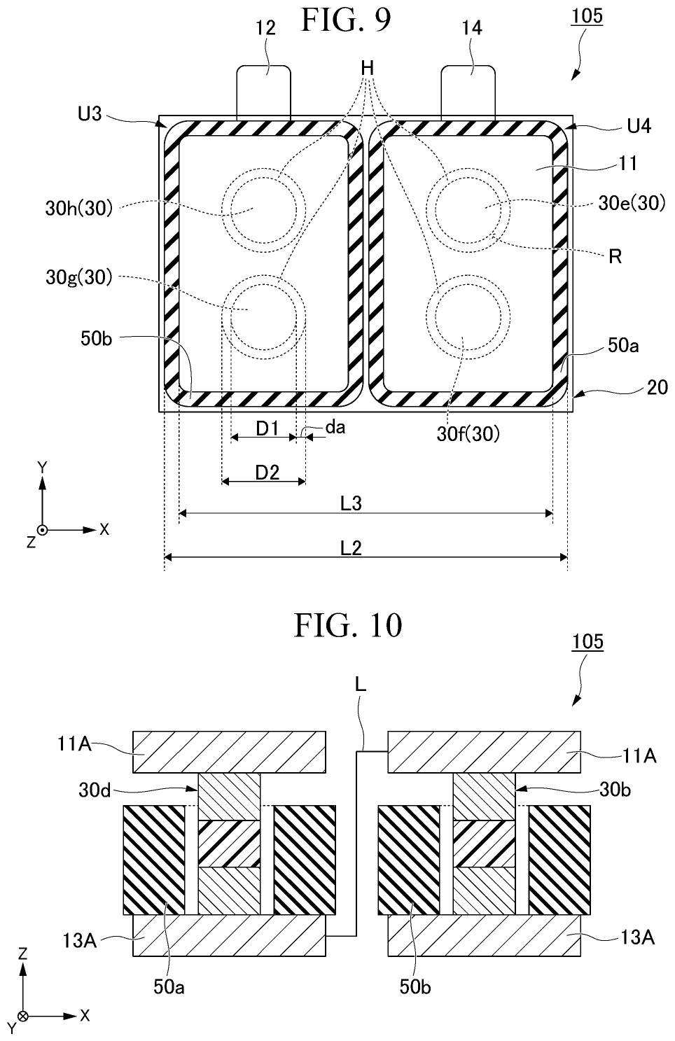

FIG. 9 is a schematic top view of an all-solid-state battery 105 according to Modification Example 4. FIG. 10 is a schematic top view of an all-solid-state battery 105 according to Modification Example 4. The all-solid-state battery 105 according to Modification Example 4 has a plurality of units. In the all-solid-state battery 105, the plurality of units are, for example, arranged in the same plane. That is, the plurality of units are arranged side by side at the same position in the z-direction. FIGS. 9 and 10 show an example of having a first unit U3 and a second unit U4. In the all-solid-state battery 105, each of the plurality of units has, for example, a plurality of laminates 30e to 30h and through-holes H. The other configuration is the same as that of the all-solid-state battery 100 according to the first embodiment, and the same configurations as therein are given the same reference numerals, and description thereof will not be repeated.

In the all-solid-state battery 105, the first unit U3 and the second unit U4 are connected to each other via, for example, a conductive wire L. The all-solid-state battery 105 is an example of a case in which the plurality of units are electrically connected in series. In the all-solid-state battery 105, the lead 12 is connected to a positive electrode current collector 11A of the first unit U3, and the leads 14 are connected to negative electrode current collectors 13A of the second unit U4.

Even with the all-solid-state battery 105 according to Modification Example 4, the same effects as those of the all-solid-state battery 100 according to the first embodiment are obtained. In addition, in the all-solid-state battery 105 shown in FIGS. 9 and 10, since two units are electrically connected in series, the voltage output is approximately doubled. In addition, in the all-solid-state battery 105, since two laminates are arranged in one unit, the battery capacity is doubled.

### Modification Example 5

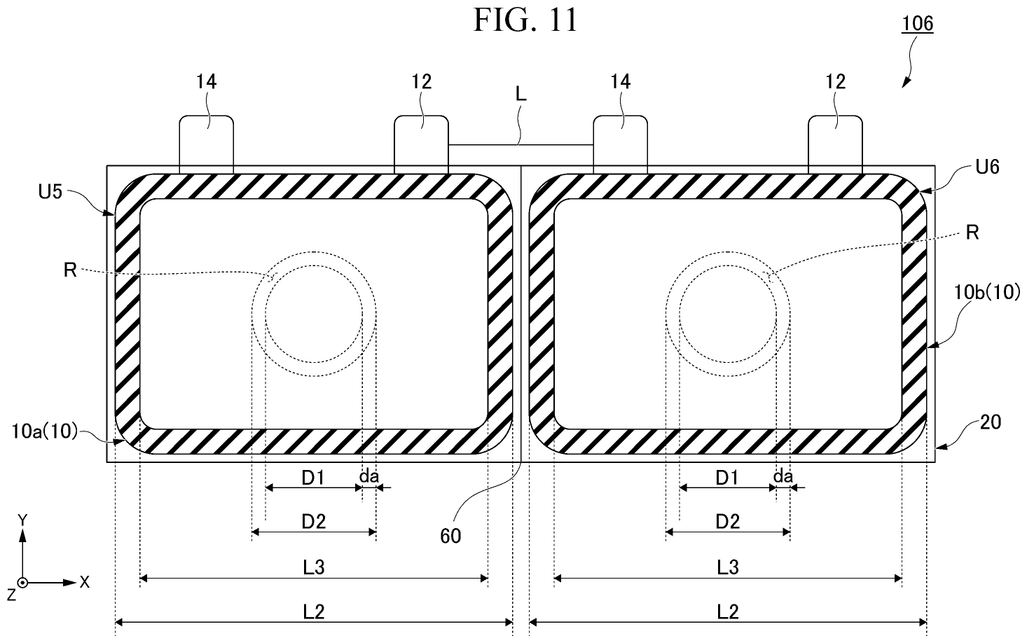

FIG. 11 is a schematic top view of an all-solid-state battery 106 according to Modification Example 5. The all-solid-state battery 106 according to Modification Example 5 has a plurality of power storage elements 10a and 10b in the same plane, and the power storage elements 10a and 10b are electrically connected in series. In the all-solid-state battery 106 according to Modification Example 5, the same configurations as in the all-solid-state battery 100 according to the first embodiment are given the same reference numerals, and description thereof will not be repeated.

In the all-solid-state battery 106 according to Modification Example 5, the plurality of power storage elements 10a and 10b are, for example, housed in the same exterior body 20. In the all-solid-state battery 106 according to Modification Example 5, the power storage element 10a and the power storage element 10b are, for example, connected to each other via a conductive wire L. In the all-solid-state battery 106, an insulating seal 60 may be provided between the adjacent power storage elements 10. The power storage element 10a has a first unit U5, and the power storage element 10b has a second unit U6.

Even with the all-solid-state battery 106 according to Modification Example 5, the same effects as those of the all-solid-state battery 100 according to the first embodiment are obtained. In addition, in the all-solid-state battery 106, since the plurality of power storage elements are electrically connected in series, the voltage output increases compared to the all-solid-state battery 100 according to the first embodiment. The increase in the voltage output depends on the number of power storage elements 10. In the configuration including two power storage elements as shown in FIG. 11, the voltage output is doubled. The drawing shows an example in which the insulating seal 60 is provided and the lead 12 is connected to the lead 14 outside the exterior body 20. The present embodiment is not limited to this example, and has a series structure in which a positive electrode current collector 11A and a negative electrode current collector 13A of adjacent power storage elements 10 are connected to each other inside the exterior body 20 without the insulating seal 60.

The embodiment of the present invention has been described in detail above with reference to the drawings. However, each configuration and combination of each embodiment is merely an example, and addition, omission, replacement, and other modifications of the configuration can be made within the scope not departing from the gist of the present invention.

### EXAMPLES

Hereinafter, the effect of the present invention will be made more apparent using an example. The present invention is not limited by the following example and can be implemented with appropriate modifications within the scope not changing the gist of the present invention.

### Example 1

An all-solid-state battery of the above-described embodiment was experimentally manufactured, and AC electrical resistance (internal resistance) between a positive electrode current collector and a negative electrode current collector was measured. The thickness T2 of an insulating film was set to 250 μm, and the thickness T1 of an electrode was set to 300 μm. Constituent materials for the insulating film and each layer of the electrode were as follows.
Positive electrode current collector: 20 μm thick aluminum foil
Positive electrode active material: LCO (LiCoO₂)
Negative electrode current collector: 20 μm thick aluminum foil
Negative electrode active material: LTO (Li₄Ti₅O₁₂)
Solid electrolyte: LZSOC (Li₂ZrSO₄Cl₄)
Conductive assistant: Positive electrode-side carbon black, negative electrode-side graphite
Binding material: None
Insulating film: PET sheet

### Examples 2 and 3

The same configuration as in Example 1 was used except that the thickness T2 of each insulating film was set to 200 μm and 100 μm, and AC electrical resistance was measured in the same manner as in Example 1.

### Comparative Examples 1 to 3

The same configuration as in Example 1 was used except that the thickness T2 of each insulating film was set to 400 μm, 300 μm, and 50 μm, and AC electrical resistance was measured in the same manner as in Example 1.

The measurement results of Examples 1 to 3 and Comparative Examples 1 to 3 are shown in Table 1. It can be seen that, when the thickness Ti is greater than the thickness T2, the AC electrical resistance is kept low. It can be seen that, when the thickness ratio T2/T1 is 0.17 or less, the electrical resistance is low, but electrode deviation occurs.

TABLE 1

| | | | | | Occurrence |
|---|---|---|---|---|---|
| | Thickness [μm] | | | AC resistance | proportion of |
| | Thickness T2 of | Thickness T1 of | | [Ω] | electrode |
| Sample | insulating film | electrode | T2/T1 | (1 kHz) | deviation [%] |
| Comparative | 400 | 300 | 1.33 | 3000 | 0 |
| Example 1 | | | | | |
| Comparative | 300 | 300 | 1 | 2500 | 0 |
| Example 2 | | | | | |
| Comparative | 50 | 300 | 0.17 | 230 | 20 |
| Example 3 | | | | | |
| Example 1 | 250 | 300 | 0.83 | 230 | 0 |
| Example 2 | 200 | 300 | 0.67 | 230 | 0 |
| Example 3 | 100 | 300 | 0.33 | 230 | 0 |

### Example 4

An all-solid-state battery of the above-described embodiment was experimentally manufactured, and occurrence proportions (number of occurrences/number of trial products) of electrode deviation and electrode cracks when an electrode was inserted from a through-hole were measured. The distance 2da corresponding to the difference in diameter of the through-hole and the electrode was set to 0.1 mm. Constituent materials for an insulating film and each layer of the electrode were set to be the same as in Example 1.

### Examples 5 to 7

The same configuration as in Example 4 was used except that each distance 2da was set to 0.1 mm, 0.3 mm, 0.5 mm, and 1 mm, and the number of electrode deviations and electrode cracks were measured in the same manner as in Example 4.

### Comparative Examples 4 and 5

The same configuration as in Example 4 was used except that each distance 2da was set to 0 mm and 1.5 mm, and the number of electrode deviations and electrode cracks were measured in the same manner as in Example 4.

The measurement results of Examples 4 to 7 and Comparative Examples 4 and are shown in Table 2. It can be seen that, when the distance 2da is 0.1 mm to 1 mm, the occurrence of electrode cracks and electrode deviation is suppressed.

TABLE 2

| | | Occurrence | Occurrence |
|---|---|---|---|
| | | proportion of | proportion of |
| | Distance 2 da | electrode | electrode |
| Sample | [mm] | cracks [%] | deviation [%] |
| Comparative | 0 | 30 | 40 |
| Example 4 | | | |
| Comparative | 1.5 | 0 | 20 |
| Example 5 | | | |
| Example 4 | 0.1 | 0 | 0 |
| Example 5 | 0.3 | 0 | 0 |
| Example 6 | 0.5 | 0 | 0 |
| Example 7 | 1 | 0 | 0 |

### Example 8

An all-solid-state battery of the above-described embodiment was experimentally manufactured, and short-circuit currents between an electrode and a positive electrode current collector, between the electrode and a negative electrode current collector, and between the positive electrode current collector and the negative electrode current collector were measured. In a plan view in a laminating direction of the electrode, the distance between the outer circumference of the positive electrode current collector and the outer circumference of the electrode and the distance between the outer circumference of the negative electrode current collector and the outer circumference of the electrode were set to 0.5 mm. These distances are called clearances below. Constituent materials for an insulating film and each layer of the electrode were set to be the same as in Example 1.

### Examples 9 and 10

The same configuration as in Example 8 was used except that each clearance was set to 1 mm and 2 mm, and the short-circuit currents were measured in the same manner as in Example 8.

### Comparative Examples 6 and 7

The same configuration as in Example 8 was used except that each clearance was set to 0 mm and 0.4 mm, and the short-circuit currents were measured in the same manner as in Example 8.

The measurement results of Examples 8 to 10 and Comparative Examples 6 and 7 are shown in Table 3. It can be seen that, if the clearance is 0.5 mm or more, the occurrence of the short-circuit currents is suppressed.

TABLE 3

| | Clearance | Number of occurrences of |
|---|---|---|
| Sample | [mm] | short-circuits |
| Comparative Example 6 | 0 | 20 |
| Comparative Example 7 | 0.4 | 10 |
| Example 8 | 0.5 | 0 |
| Example 9 | 1 | 0 |
| Example 10 | 2 | 0 |

### INDUSTRIAL APPLICABILITY

According to the present invention, it is possible to provide an all-solid-state battery capable of suppressing deviation and cracks of a laminate and occurrence of short circuits.

### REFERENCE SIGNS LIST

10 Power storage element
11 Positive electrode layer
11A Positive electrode current collector
11B Positive electrode active material layer
13 Negative electrode layer
13A Negative electrode current collector
13B Negative electrode active material layer
15 Solid electrolyte layer
20 Exterior body
30 Laminate
50 Insulating film
100 All-solid-state battery
H Through-hole

1. An all-solid-state battery comprising:
a positive electrode layer including a positive electrode active material layer and a positive electrode current collector;
a negative electrode layer including a negative electrode active material layer and a negative electrode current collector;
a solid electrolyte layer; and
an insulating film,
wherein the insulating film has therein a through-hole in which a laminate in which the positive electrode active material layer, the solid electrolyte layer, and the negative electrode active material layer are sequentially stacked is housed,
wherein the laminate and the insulating film are arranged between the positive electrode current collector and the negative electrode current collector, and
wherein an external shape of the insulating film is larger than external shapes of the positive electrode current collector and the negative electrode current collector when viewed in a plan view in a laminating direction of the laminate.

2. The all-solid-state battery according to claim 1,
wherein the laminate is thicker than the insulating film.

3. The all-solid-state battery according to claim 1,
wherein the laminate is arranged apart from the insulating film by 0.1 mm to 1 mm when viewed in a plan view in a laminating direction.

4. The all-solid-state battery according to claim 1,
wherein the insulating film is a resin.

5. The all-solid-state battery according to claim 1, further comprising:
a plurality of the laminates,
wherein the insulating film has a number of through-holes corresponding to the number of the laminates, and
wherein the plurality of laminates are respectively housed in the through-holes.

6. The all-solid-state battery according to claim 1, further comprising:
a plurality of units each having the positive electrode layer, the negative electrode layer, the solid electrolyte layer, and the insulating film,
wherein the plurality of units are electrically connected in series.

7. The all-solid-state battery according to claim 1, further comprising:
a plurality of units each having the positive electrode layer, the negative electrode layer, the solid electrolyte layer, and the insulating film,
wherein the plurality of units are electrically connected in parallel.
